(19) United States
(12) Patent Application Publication
(10) Pub. No.: US 2022/0306246 A1
(43) Pub. Date: Sep. 29, 2022

(54) PUSHER MECHANISM AND SYSTEM FOR TENSIONING A STRAP INCLUDING SUCH MECHANISMS

(71) Applicant: PUSH4M, Groix (FR)

(72) Inventor: Nicolas De Lussy, Groix (FR)

(21) Appl. No.: 17/641,942

(22) PCT Filed: Sep. 8, 2020
(86) PCT No.: PCT/EP2020/075119

§ 371 Date: Mar. 10, 2022

(30) Foreign Application Priority Data
Sep. 12, 2019 (FR) 1910066

(51) Int. Cl. B63B 23/08; F16G 11/12; F16H 25/18

(52) U.S. Cl. CPC B63B 23/08; F16G 11/12; F16H 25/183

(57) ABSTRACT

The present invention relates to a pusher mechanism comprising a column (1) capable of being subjected to a compressive force or a pulling force when in use and having a height (H) defining a first direction, a width (l) and a thickness (E), the thickness (E) being constant, the height (H) being variable, when in use, between a quiescent value (H₀) and a maximum value (H_{M}) and the width (l) being variable, when in use, between a quiescent value (l₀) and a minimum value (lᵢₙ), the column comprising two vertical members (2, 3) facing each other and extending along the height (H) and the thickness (E), and reversible means (6) supported by the vertical members and designed to transform a compressive force exerted on the vertical members along the width (l) of the column into a movement along the first direction of the column, the width (l) of which subsequently decreases (l<l₀) and the height (H) of which subsequently increases (H>H₀), and vice versa.

The present invention relates to the technical field of pusher mechanisms.

Such means are well known and can consist of vertical pistons or of rods fixed to rotary cams.

They do however present drawbacks, when a plurality of devices is used with a single driving source and there is a wish to individually control each of the devices. It is in fact then necessary to provide distributors and a control system. The means as a whole then become very heavy, complex and difficult to manufacture and to manage in operation. The aim of the invention is to mitigate these drawbacks by proposing a pusher mechanism of a radically different design and which is notably based on observation of how the muscle of an arm, and more particularly of the biceps, operates.

In fact, to lift a load by the hand situated at the end of the forearm, the length of the muscle of an arm decreases and the muscle stiffens by increasing the transverse volume of its constituent muscular fibers.

This is why the pusher mechanism according to the invention will be advantageously applicable in strap tensioning devices, for example to allow a load to be lifted from a distance.

Thus, the invention relates to a pusher mechanism comprising a column capable of being subjected to a compression or pulling force in operation and having a height (H) defining a first direction, a width (l) and a thickness (E), the thickness (E) being constant, the height (H) being variable in operation between a value at rest (H₀) and a maximum value (H_{M}) and the width (l) being variable in operation between a value at rest (l₀) and a minimum value (lₘ), said column comprising two uprights facing one another extending according to the height (H) and the thickness (E), and reversible means supported by said uprights and designed to convert a compression force exerted on the uprights according to the width (l) of the column into a movement according to said first direction of the column whose width (l) then decreases (l<l₀) and whose height (H) increases (H>H₀), and vice versa.

In advantageous embodiments, there is recourse to one or other of the following provisions:
the reversal means comprise:
   at least two corner-forming first parts which extend according to the thickness (E) and have at least one surface defining a first plane that is inclined with respect to a plane at right angles to said first direction, said at least two first parts being each secured to one of the two facing uprights, by being situated on different uprights, and
   at least one complementary second part which extends according to the thickness (E) and has two surfaces each defining a second plane that is inclined with respect to said plane, this at least one second part being disposed between two first parts,
      the first inclined plane of a first part being designed to slip over one of the second inclined planes of the second part, such that a slippage of the corner-forming first parts over said at least one second part drives a movement according to said first direction of the at least one second part.

The uprights are produced in at least two independent parts, the height, the width and the thickness of which are constant, their height being less than (H₀).

Said at least two corner-forming first parts are facing or offset according to the height (H) of the column.

The column comprises several complementary second parts disposed adjacent according to said first direction, elastic means being provided to hold said second parts according to this arrangement, during the movements of these second parts according to said first direction.

The invention relates also to a pusher device allowing the generation of a series of thrusts that are staggered in time, comprising at least three pusher mechanisms according to the invention, linked to one another by their adjacent uprights.

Advantageously, at least two columns have adjacent uprights linked to one another by a vertical guideway link.

The invention relates also to a system for tensioning a non-extendible or substantially non-extendible strap extending longitudinally between a distal end portion and a proximal end portion, respectively fixed to corresponding attachment points, characterized in that it comprises at least three pusher mechanisms according to the invention, namely a first pusher mechanism for the transverse tensioning over a first central portion of the strap, and two pusher mechanism for the transverse tensioning over a second and a third portions of strap situated on either side of the first central portion.

Advantageously, the system also comprising a lever arm extending longitudinally between a proximal part and a distal part supporting a load, the proximal part being rotationally mobile about an axis fixed to a base, the distal portion of the strap, for its part, being fixed to said proximal part of the arm by one of the attachment points, and the proximal end portion of the strap being fixed to a fixed point forming the second of the attachment points.

Preferably, the number of pusher mechanisms is equal to n+2 (n≥3), these means being distributed longitudinally along the strap, symmetrically with respect to the central pusher mechanism situated equidistantly between the fixed point and a pulley or a rotary return cylinder situated in the same longitudinal plane as the fixed point.

The invention will be better understood, and other aims, advantages and features thereof will become more clearly apparent, on reading the following description of embodiments given as nonlimiting examples, and which is made with respect to the attached drawings in which:

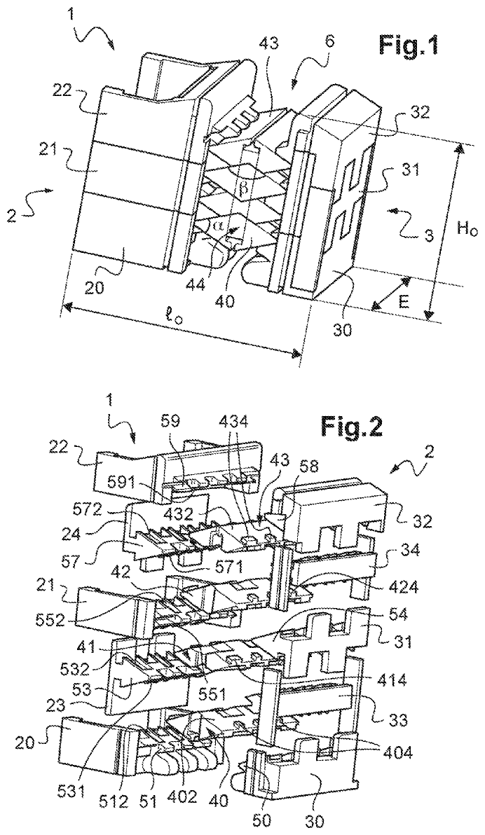

FIG. 1 is a three-quarter front view of an exemplary pusher mechanism according to the invention in the state of rest.

FIG. 2 is a perspective and exploded view of FIG. 1.

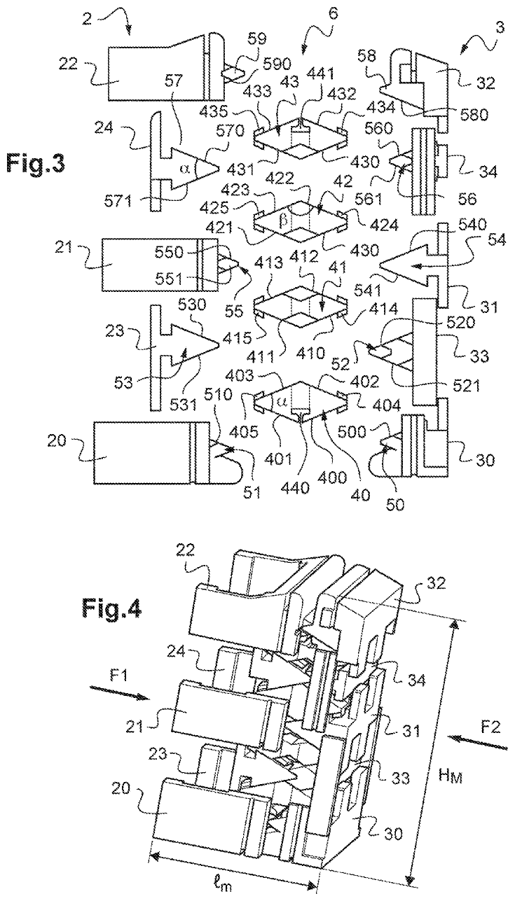

FIG. 3 is a front-end view of FIG. 2.

FIG. 4 is a perspective view of the pusher mechanism of FIG. 1 in compressed position.

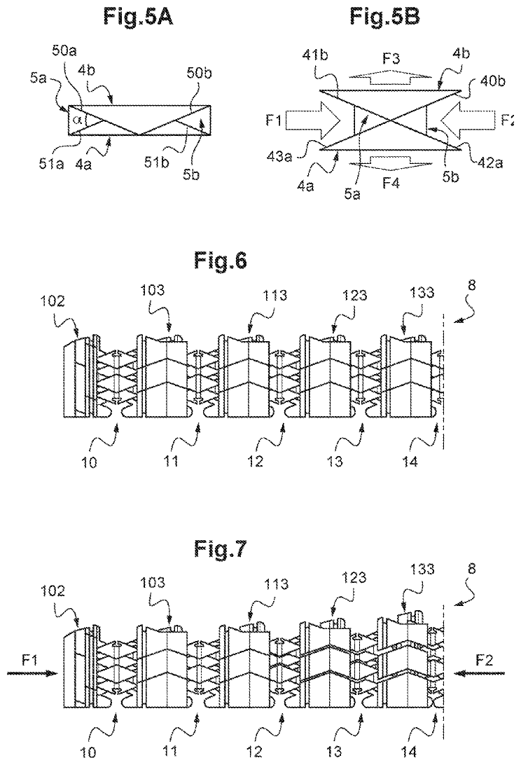

FIG. 5 comprises FIGS. 5A and 5B which are diagrams explaining the principle of operation of a pusher mechanism according to the invention.

FIG. 6 is a front-end view illustrating a device according to the invention, only half of this device being illustrated.

FIGS. 7 to 10 are front-end views of the pusher device illustrated in FIG. 6, representing four different steps of the compressing of the system illustrated in FIG. 6, when a tension is exerted on the device.

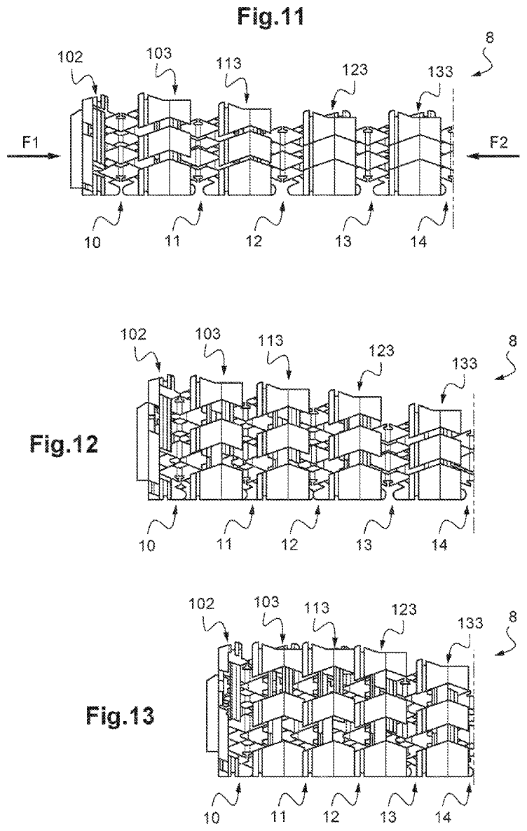

FIGS. 11 to 13 are front-end views illustrating the device of FIG. 6 when it is being compressed without a load.

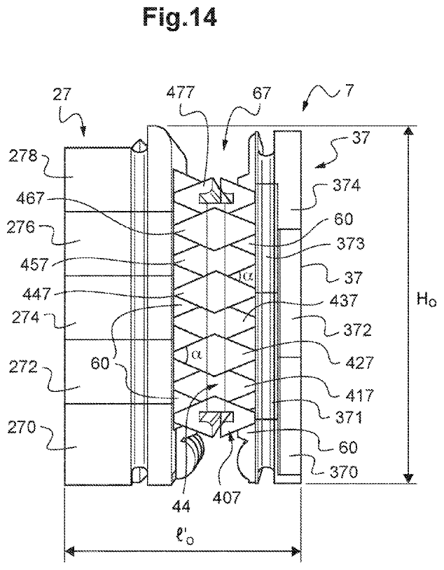

FIG. 14 is a front-end view illustrating a pusher mechanism according to the invention, in the state of rest, having a form different from the pusher mechanism illustrated in FIG. 1.

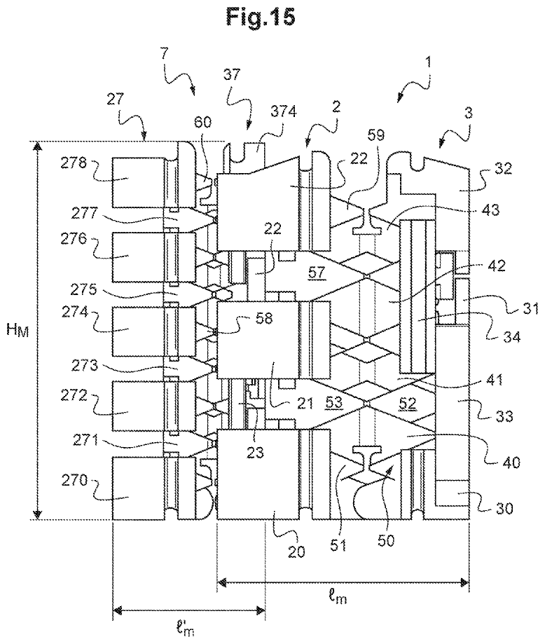

FIG. 15 illustrates a pusher device formed by two pusher mechanisms as illustrated in FIGS. 1 and 14, after having undergone a compression.

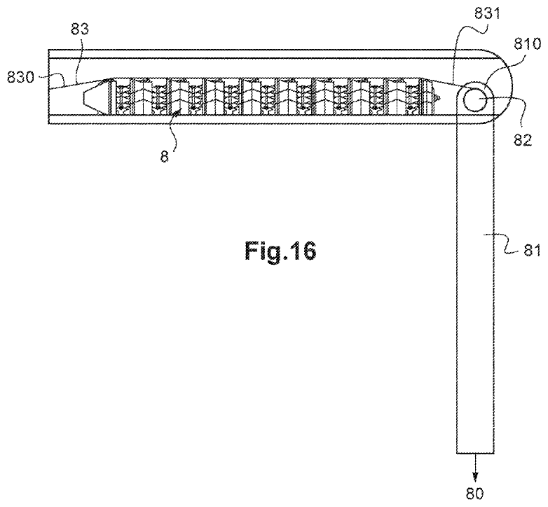

FIGS. 16 to 19 are front-end views illustrating a load lifting mechanism using a pusher device according to the invention, during different steps of operation.

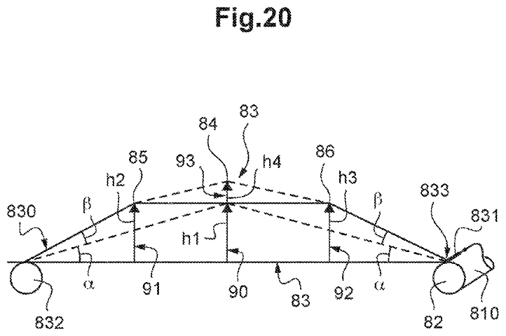

FIG. 20 is a skeleton diagram illustrating the operation of a pusher device according to the invention with a strap exerting a pressure on the device.

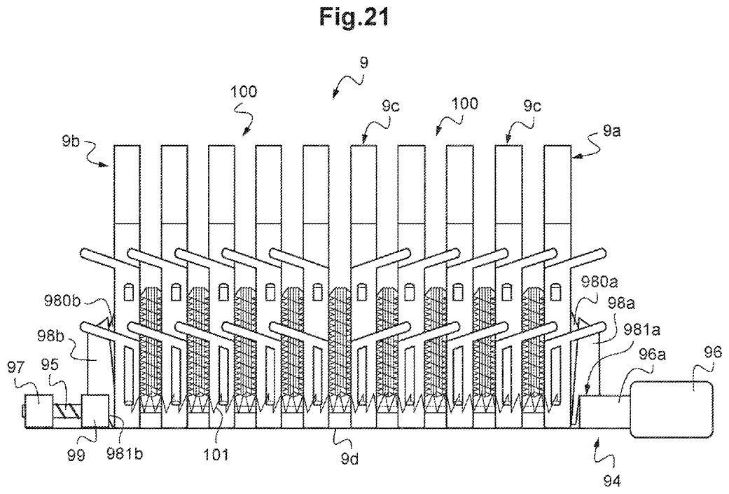

FIG. 21 is a front-end view of another pusher device according to the invention illustrating actuation means, the pusher device being in decompressed position.

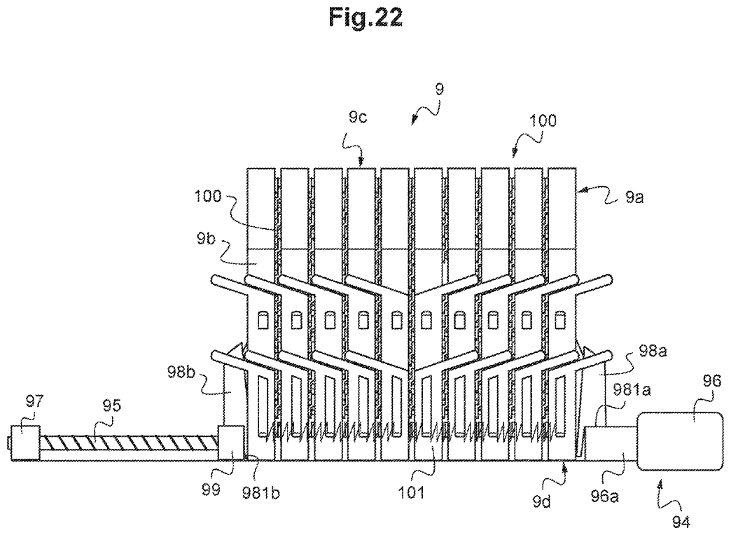

FIG. 22 is a front-end view of the device illustrated in FIG. 21, in compressed position.

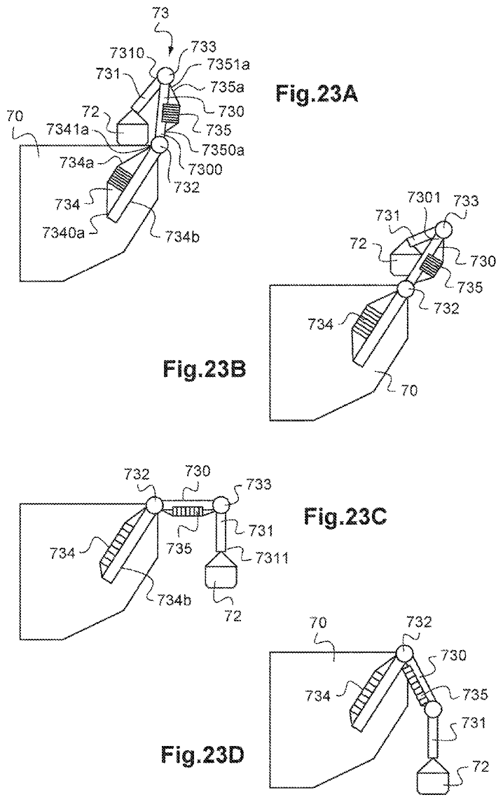

FIGS. 23A to 23D are diagrams illustrating different steps of operation of a device according to the invention for the lowering of a lifeboat.

The elements that are common to the different figures will be illustrated by the same references.

Referring first of all to FIGS. 1 to 3, these figures illustrate an example of a pusher mechanism according to the invention.

This mechanism comprises a column 1 with two uprights 2, 3 facing one another, between which there are disposed means 6 which will be described in more detail.

This column has a height (H) which is, here, equal to (H₀), the mechanism being at rest, that is to say that no compression or pulling force is being exerted on the column 1.

This value (H₀) is the minimum value of the height of the column 1.

Each of the uprights extends over this height (H), here equal to H₀.

The column 1 also has a width (l) which is, here, equal to (l₀), the value of the width of the column at rest, that is to say in the absence of any compression or pulling force.

This value (l₀) corresponds to the maximum width of the column.

Finally, this column 1 has a thickness (E), this value (E) remaining constant throughout the operation of the pusher mechanism. This notion of “constant” means that the value (E) has a very low variation margin, that is to say less than 10% and preferably less than 5% with respect to the value of the thickness of the mechanism when it is at rest.

Conversely, the dimensions (H) and (l) are variable because they vary in much greater proportions, for example by at least 25% with respect to their value in the position of rest of the pusher mechanism, this variation being advantageously by at least 50%, even by at least 100% for (H).

Each of the uprights also extends over this thickness (E) and has a determined width.

The height (H) of the two uprights 2 and 3 defines a first direction which is a vertical direction when the pusher mechanism is disposed on a flat support, the two uprights 2 and 3 bearing on this support. This can consist of a strap.

In the example illustrated in FIG. 1, each of the two uprights 2 and 3 is formed by several independent parts, three of them, respectively 20, 21 and 22 and 30, 31 and 32, being visible in FIG. 1. The height, the width and the thickness of each of these parts are constant but these various parts can move apart from one another according to the direction defined by the height (H), as will be described later.

The means 6 will now be described in more detail with reference to FIGS. 2 and 3 which show the column 1 in exploded view.

First of all, these two figures show that each of the columns 2 and 3 comprises two complementary parts inserted between those illustrated in FIG. 1.

Thus, for the upright 2, there are inserted between the constituent parts 20 and 21, another part 23 and, between the constituent parts 21 and 22, another part 24.

Likewise, for the upright 3, between the parts of upright 30 and 31 illustrated in FIG. 1, there is inserted another part 33 and, between the constituent parts 31 and 32, there is inserted another part 34.

The means 6 are composed of an assembly of complementary first parts and second parts which will now be described.

The first parts are corner-forming parts which extend according to the thickness (E) of the column 1.

The first parts 51, 53, 55, 57 and 59 are secured to the upright 2, while the parts 50, 52, 54, 56 and 58 are secured to the upright 3.

Each of these first corner-forming parts 50 to 59 is, here, secured to a constituent part of the corresponding upright.

Each of them has a triangular front-end section with a vertex angle α which is identical for all these first parts.

This angle α is for example substantially equal to 22° when the constituent material of the first parts (and of the second parts described next) is steel.

Moreover, each of these first parts defines a first plane 510 to 590, inclined with respect to a transverse plane, that is to say a plane at right angles to the first direction defined by the height of the uprights of the column, by an angle α/2.

It will be noted in FIGS. 2 and 3 that some first parts, 52 to 57, define another first inclined plane 521 to 571 which is symmetrical to the first inclined plane 530 to 570 with respect to a transverse plane.

The means 6 also comprise four second parts 40 to 43, complementing the first parts, and which extend also according to the thickness (E) of the column.

Each of these second parts has two surfaces each defining a second plane which is inclined with respect to a sagittal plane.

In the example illustrated in the figures, each of these second parts has a section in the front-end plane of rhomboid form, so that it has four surfaces each defining a second plane that is inclined with respect to a transverse plane.

As FIGS. 1 to 3 illustrate, these four surfaces are symmetrical pairwise with respect to a sagittal plane and with respect to a transverse plane.

Thus, for example for the second part 40, the inclined planes 400, 402, on the one hand, and 401, 403, on the other hand, are symmetrical with respect to a sagittal plane and each of these two pairs define a vertex angle α, identical to that defined by the corner-forming first parts. The planes 400 to 403 are therefore inclined by an angle α/2 with respect to a transverse plane.

Moreover, the inclined planes 400, 401, on the one hand, and 402, 403, on the other hand, are symmetrical with respect to this transverse plane and form a vertex angle β. These planes 400 to 403 are therefore inclined by an angle β/2 with respect to this sagittal plane.

Moreover, these figures show that a second part is disposed between two first parts.

Thus, for example for the second part 41, the latter is situated between the two first parts 52 and 53 which are secured to two facing uprights and situated at the same height.

It can also be considered that this second part 41 is situated between the two first parts 53 and 54, secured to the two facing uprights, but this time offset according to the height (H) of the column.

It is understood that with the choice of the same angle α, a first inclined plane of a first part is designed to slip over one of the second inclined planes of the second part.

Thus, for the second part 41, the first inclined plane 530 of the first part 53 is designed to slip over the second inclined plane 411 of the second part 41.

Likewise, the first inclined plane 520 of the first part 52 is designed to slip over the second inclined plane 410 of the second part 41.

The same applies for the first inclined plane 541 of the second part 54, over the second inclined plane 412 of the second part 41.

The complementary second parts 40 to 43 are disposed in the means 6 in such a way that the edges of each of these parts corresponding to the vertex angle β are aligned according to the first direction of the column defined by its height (H).

When the pusher mechanism illustrated in FIG. 1 is in the assembled state, the second parts are held in this position by virtue of elastic means 44. These means allow a relative movement of these second parts according to the first direction.

So as to hold the first parts and the second parts facing one another to ensure the relative slippage thereof, stops 404, 405 to 434, 435 are provided on the second parts 40 to 43 and cooperate with guideways 512 to 572 provided on the top face of the first parts 50 to 57 and guideways 531 to 591 provided on the bottom face of the first parts 50 to 59 (only the guideways provided on the first parts 51 to 59 are visible in FIG. 2).

FIG. 3 shows that the second parts 40 and 43 situated at the two ends of the column comprise notches 440, 441 for the passage of these elastic means.

The invention is of course not limited to this embodiment and another system could be provided to hold the second parts according to this arrangement.

Referring now to FIG. 4, this figure illustrates the column 1 of the pusher mechanism after a compression force has been exerted on each of the uprights 2 and 3 according to the width of the column and toward the interior of the column.

This compression force is illustrated by the arrows F₁ and F₂.

This compression force is exerted on the column 1 by any appropriate means which may or may not form part of the pusher mechanism. They can be mechanical means: cylinders, wormscrew vices, cables wound on a winch, hydraulic cylinders or pneumatic cylinders for example. An embodiment of such actuation means is described with reference to FIGS. 21 and 22.

It is also possible to envisage producing the pusher mechanism in a material that is deformable under the action of an electrical field, such as a dielectric elastomer for example. The action of the electrical field would then be reflected also by a compression or pulling force.

When such a compression force is exerted on the uprights of the column, the corner-forming first parts slip over the inclined planes defined by the complementary second parts, approaching the interior of the column. This movement of the first parts provokes the movement of the second parts apart from one another, according to the first direction of the column, and the movement apart from one another of the various constituent parts of each of the uprights, still according to this first direction.

FIG. 4 thus illustrates the column 1 in totally compressed position.

It can be seen that, in this position, the height (H) of the column has increased to reach a maximum value (H_{M}). Moreover, the width (l) of the column has decreased to reach a minimum value (lₘ).

The effect generated by the relative slippage of the first parts and second parts is schematically illustrated in FIGS. 5A and 5B.

These figures schematically illustrate two corner-forming first parts 5a and 5b, and two complementary second parts 4a and 4b.

The first parts 5a and 5b define two first planes inclined with respect to the sagittal plane, referenced 50a, 51a and 50b, 51b, each pair defining a vertex angle α.

Likewise, the two complementary parts 4a and 4b define a pair of inclined planes 42a, 43a and 40b, 41b defining a vertex angle β and symmetrical with respect to a transverse plane.

FIG. 5A illustrates the assembly of the four parts at rest, with the second parts disposed adjacent according to a transverse plane and the first parts facing one another and bearing on the outer part of the inclined planes defined by the second parts.

FIG. 5B illustrates the assembly illustrated in FIG. 5A, after a compression force, schematically represented by the arrows F1 and F2, has been exerted on the first parts 5a and 5b, toward the interior of the assembly.

FIG. 5B shows that the first parts 5a and 5b then slip over the inclined planes of the second parts with which they are in contact and provoke the movement apart of the second parts 5a and 5b.

The latter are therefore moved according to the arrows F3 and F4.

The height of the assembly therefore increases from its position of rest when a compression force is exerted on it.

Generally, the maximum height of the assembly depends on the length of the inclined planes of the first and second parts and on the vertex angle α.

The operation of this assembly is reversible.

Thus, if pulling forces, that is to say in a direction opposite to that of the arrows F1 and F2, are exerted on the first parts 5a and 5b, the second parts 4a and 4b will converge toward one another to return to the position of rest illustrated in FIG. 5A.

However, in the absence of pulling force, the assembly keeps the position that it has reached, even if the compression force has stopped being exerted. This is obtained by virtue of the friction between the inclined planes of the first and second parts.

As an example, this stability of the assembly can be obtained when all the parts are made of steel with an angle α less than 22°, the friction coefficient being 0.2.

Thus, generally, the angle α is chosen as a function of the constituent material of the parts so as to ensure the stability of the device while keeping the compression or pulling force needed to ensure the operation of the device at a minimum value.

Referring now to FIG. 6, this figure illustrates a pusher device 8 according to the invention which comprises nine columns, only half of the device being illustrated. This device is in the state of rest.

FIG. 6 therefore shows columns 10 to 13 and, partially, column 14.

Each of these columns is of the type of that illustrated in FIG. 1 and they are arranged adjacent to one another.

In addition, two adjacent columns, like the columns 10 and 11, have adjacent uprights linked to one another by a link of vertical guideway type.

Thus, the upright 103 combines two uprights of the columns 10 and 11. The same applies for the upright 113 and the columns 11 and 12, for the upright 123 and the columns 12 and 13 and, finally, for the upright 133 and the columns 13 and 14.

The operation of the pusher device 8 illustrated in FIG. 6 will first of all be illustrated with reference to FIGS. 7 to 10.

In this mode of operation, the pusher device 8 is disposed on a flat solid support (not illustrated in the figures) and the columns 10 to 14 therefore then extend according to a first direction which is vertical, with respect to this horizontal support. This support is chosen to facilitate the slippage of the columns when the pusher device is in operation.

Furthermore, in this mode of operation, a strap is taut on either side of the pusher device 1 and exerts a pressure on this device, on the side opposite the base, or even on the upper part of the device.

This strap is non-extendible or substantially non-extendible and reference can be made to FIGS. 16 to 19 which will be described later, to view its positioning with respect to the pusher device.

A substantially non-extensible member is understood to be a member arranged to undergo an elongation less than 5% of its length for a determined maximum tension less than its breaking point, for example 500 MPa. This elongation is, for example, less than 3%, advantageously less than 1%, even 0.5% or 0.05%.

FIG. 7 illustrates a step of the operation of the pusher device according to the invention, after a compression force has begun to be exerted on the end uprights 102 of the device, according to the width of the device. This compression force is schematically represented by the two arrows (F₁) and (F₂).

FIG. 7 shows that this compression force has mainly had an effect on the columns situated at the center of the device. In fact, only the various constituent parts of the uprights 123 and 133 have begun to move apart from one another, this movement apart being greater for the upright 133 situated nearest the center of the device.

It is understood that, in as much as the device is placed on a solid support, the columns are deformed according to the first direction, by moving away from this support.

In other words, the second parts of each of the columns move apart from one another by being displaced vertically, in as much as the support is horizontal, whereas the width of these columns decreases.

FIG. 8 illustrates a next step, after the compression force has continued to be exerted on the end uprights of the pusher device.

FIG. 8 shows that the constituent parts of all the uprights have moved apart from one another, the movement apart being, however, greater for the upright 133 situated closest to the center of the device, this movement apart decreasing from the upright 123 to the upright 102.

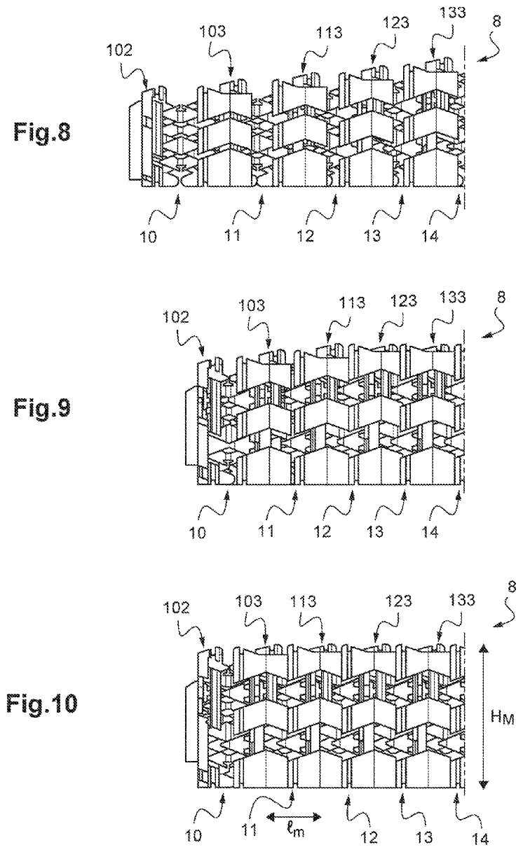

FIG. 9 illustrates another subsequent stage in the operation of the device when a compression force has continued to be exerted.

It will be observed that the upright 133 situated substantially in the middle of the device has practically reached its maximum height, whereas the other uprights 123 to 102 have seen their constituent parts increasingly move apart from one another.

Finally, FIG. 10 illustrates the totally compressed position of the pusher device according to the invention. All the uprights 133 to 102 have reached the maximum height (H_{M}), as illustrated in FIG. 4, while the width of each of the columns 10 to 14 has reached its minimum value (lₘ).

In this mode of operation with a strap exerting a pressure, the various columns are deformed according to the following principle, illustrated in FIG. 20, so as to act on the strap.

The pusher device considered comprises three columns, for example of the type illustrated in FIG. 1, spaced apart from one another.

Moreover, the strap 83 is fixed by its proximal end portion 830 to a base 832 and by its distal end portion 831 to the proximal part 810 of a lever arm.

The reference 82 denotes the axis about which the lever arm is rotationally mobile and the reference 833 denotes a fixed axis holding the strap. The references 84, 85 and 86 each denote the center of a portion of strap, the latter being therefore divided into three portions.

In the example illustrated in FIG. 20, these centers are substantially equidistant from one another and with the fixed points 832 and 833.

A column (not represented) is disposed facing each of these three centers.

In the state of rest, the strap 83 extends horizontally between the base 832 and the axis 82 (position illustrated by a solid line).

A compression exerted on the pusher device generates a first tensioning, schematically represented by the arrow 90, on the substantially central portion of the strap 83 (schematically represented by its center 84). This pressurizing causes this portion to be lifted by a height h1 and results in the formation of an angle α between the direction of the strap at rest and after this first pressurizing (position illustrated by dotted lines in FIG. 20).

This first pressurizing, like the subsequent ones, is exerted at right angles to the initial position of the strap, that is to say, here, vertically.

The compression on the pusher device generates, simultaneously or successively, a second and a third pressurizing, schematically represented by the arrows 91 and 92.

Each of these tensionings is exerted on a lateral portion of the strap (schematically represented by its center 85, 86) and causes this portion of strap to be lifted by a height h2, h3.

It therefore leads to the formation of an angle β between the direction of the strap 83 after the first pressurizing (illustrated by dotted lines) and after the second and third pressurizings (illustrated by solid lines).

The compression on the pusher device also generates a fourth pressurizing, this time on the substantially central portion of the strap, schematically represented by the arrow 93. It causes this portion of strap to be raised by a height h4.

As will be explained with reference to FIGS. 16 to 19, these pressurizings make it possible to raise the strap to the extent that it is non-extendible or substantially non-extendible, which, to compensate, causes a movement of the lever arm which will turn about the axis 82 in a counter-clockwise direction.

Obviously, FIG. 20 is only a skeleton diagram and, in practice, the pusher device according to the invention can generate a succession of thrust cycles on the strap, and do so over more than three portions of strap if the device comprises more than three columns.

Any portion of a strap can still be deformed under the effect of a column which is deformed in height (and therefore in width) if this column is surrounded by two adjacent columns compressed by the strap.

Obviously, the operation of the pusher device 8 illustrated in FIG. 6 is reversible.

In other words, if a pulling force, that is to say opposite the compression force schematically represented by the arrows F1 and F2, is exerted on the pusher device illustrated in FIG. 10, this device will be able to revert to the state of rest illustrated in FIG. 6, and passing through the steps of operation illustrated for example by FIGS. 9, 8 and 7.

On the other hand, in the absence of pulling force, the pusher device keeps the position in which the compression force has placed it, even if the latter is eliminated. This is made possible if sufficient friction forces exist between the facing inclined planes.

Reference will now be made to FIGS. 11 to 13 and 10, to illustrate another mode of operation of the pusher device 8 illustrated in FIG. 6.

As for the mode of operation previously described, the pusher device is disposed on a flat support (not illustrated in the figures).

On the other hand, no compression is exerted on the device 8.

FIG. 11 illustrates a step in the operation of the pusher device of FIG. 6, after a compression force has begun to be exerted on the end uprights 102 of the device, according to the width of the device. This compression force is schematically represented by the two arrows F1 and F2.

FIG. 12 shows that this compression force has essentially had an effect on the columns situated at the ends of the device. In fact, only the various constituent parts of the uprights 102 and 103 have begun to be moved apart from one another, this movement apart being greater for the upright 102 situated at the end of the device.

It is understood that, in as much as the device is placed on a solid support, the columns are deformed according to the first direction, by moving away from this support. Thus, the second parts situated between two uprights of a column tend to be moved apart from one another by moving away from the support, or even according to a vertical direction in as much as the support is horizontal.

FIG. 12 illustrates a next step, after the compression force has continued to be exerted on the end uprights of the pusher device.

FIG. 12 shows that the constituent parts of all the uprights are moved apart from one another, the movement apart being, however, greater for the upright 102 situated at the end of the device, this movement apart decreasing from the upright 102 to the upright 133.

FIG. 13 illustrates another subsequent step in the operation of the device when a compression force has continued to be exerted on the pusher device.

It will be observed that the upright 102 situated at the end of the device has practically reached its maximum value, while the other uprights 103 to 123 have seen their constituent parts increasingly move apart from one another.

As previously, FIG. 10 illustrates the totally compressed position of the pusher device according to the invention, in this second mode of operation.

Thus, all the uprights 102 to 133 have reached the maximum height (H_{M}), as illustrated in FIG. 4, while the width of each of the columns 10 to 14 has reached its minimum value (lₘ).

Here again, the operation of the pusher device 8 is reversible but stable, as explained in light of FIGS. 7 to 10.

It is also found that the operation of the pusher device according to the invention does not require any control mechanism, including in particular electronic means.

The deformation of the columns is generated only by the compression or pulling force exerted on the device.

As explained previously, the columns which are deformed first differ depending on whether a compression is or is not exerted on the upper part of the device.

Moreover, the steps of operation shown in the figures are purely illustrative. In fact, they do not reflect all the successive and alternate deformations of the different columns.

Reference is now made to FIG. 14 which illustrates a pusher mechanism according to the invention of different design to that illustrated in FIG. 1.

In the example of pusher device 8 according to the invention as illustrated in FIG. 6, all the columns of this device are identical and have the structure illustrated in FIG. 1, that is to say comprising four adjacent second parts.

The invention is not however limited to this embodiment and a column can comprise more or fewer numbers of first and second parts, the structure of the uprights of the column then being modified accordingly.

Thus, FIG. 14 illustrates a different embodiment in which the column 7 comprises two facing uprights 27 and 37 between which reversible means 67 are mounted.

FIG. 14 shows that these means 67 comprise an assembly of eight second parts 407 to 477 which are disposed adjacent according to the height H of the column 7 and held together by elastic means 44.

These means 67 also comprise a plurality of first parts 60 which are borne by the five constituent parts of each upright, respectively 270 to 278 for the upright 27 and 370 to 374 for the upright 37.

This column 7 is designed to be used in a pusher device with the column 1 illustrated in FIG. 1.

Thus, the height (H) of the column 7 is equal to (H₀), when the mechanism is at rest, that is to say in the position illustrated in FIG. 14, and no compression or pulling force is exerted on the column 7.

As for the column 1 illustrated in FIG. 1, this value (H₀) is the minimum value of the height of the column 7.

The column 7 has a width (l) which is, here, equal to (l′₀), corresponding to the value of the width of the column 7 at rest, that is to say in the absence of any compression or pulling force.

This value (l′₀) corresponds to the maximum width of the column.

Note that the structure of the upright 37 of the column 7 is different from that of the upright 27, to allow the column 7 to be connected to the column 1 via their adjacent uprights 37, respectively 2. This involves a vertical guideway link.

Thus, the uprights are nested in one another so as to allow the relative vertical slippage thereof.

Thus, when a pusher device consisting of the columns 1 and 7 is at rest, it has a height equal to H₀ and a width less than l₀+l′₀, given the nesting of the uprights 37 and 2.

In the example illustrated in FIG. 14, the vertex angle α of the first parts 60 of the column 7 is equal to the vertex angle of the first parts 50 to 59 of the column 1. Likewise, the inclined planes defined by the second parts 407 to 477 of the column 7 form, with the transverse plane, an angle α/2, like the inclined planes of the first parts 40 to 43 of the column 1. These inclined planes are not referenced in FIG. 14 in the interests of clarity.

Reference is now made to FIG. 15 which illustrates this pusher device after it has been fully compressed, following the application of a compression force on the uprights 27 and 3 of the columns 7 and 1, that is to say a force exerted according to the width of the pusher device and toward the interior of this device.

It can then be seen that the various constituent parts of each of the uprights 27, 37, 2 and 3 are moved apart from one another, whereas the corner-forming first parts 60; 50 to 59 have slipped over the inclined planes defined by the complementary second parts 407 to 477, respectively 40 to 43, so as to come practically into contact.

FIG. 15 shows that, in this position, each of the columns 1 and 7 has the same height which corresponds to the maximum value of this height (Hₘ).

Moreover, the width of each of the columns 1 and 7 has decreased to reach a minimum value, respectively (lₘ) and (l′ₘ).

Given that the uprights 37 and 2 of the columns 7 and 1 are nested in one another, the minimum width of the pusher device illustrated in FIG. 15 is less than lₘ+l′ₘ.

Thus, the embodiment illustrated by FIG. 15 shows that it is possible to design columns of different width and which nevertheless make it possible to reach the same maximum height under the effect of a compression force.

Other variants of the pusher device according to the invention can be envisaged. In particular, a pusher device according to the invention can be composed of pusher mechanisms in which the first parts and second parts have vertex angles that differ from one pusher mechanism to the other.

In fact, as explained previously, the maximum height of a pusher mechanism reached under the effect of a compression force depends on the length of the inclined planes defined by the first and second parts and on the vertex angle of the first parts and, consequently, on the inclination of the inclined planes of the second parts.

FIGS. 21 and 22 illustrate an embodiment of actuation means of a pusher device 9 according to the invention, placed on a support 9d.

This pusher device comprises ten columns 100 arranged adjacent, between two end uprights 9a, 9b, intermediate uprights 9c being common to two adjacent columns. Each of these columns is of the type of that illustrated in FIG. 1.

Elastic means 101 are provided between the uprights so as to elastically link them to one another. These means run through all of the uprights by being fixed to the two end uprights or are provided between two adjacent uprights, over all of the device.

The actuation means 94 comprise a wormscrew 95, a first end of which is linked to a motor 96 situated opposite an end upright 9a of the device and which passes right through the device 9 to extend beyond the other end upright 9b of the device.

The motor 96 is held fixed with respect to the support 9d.

The second end of the screw, opposite the first, is mounted to rotate in a bearing 97, also held fixed with respect to the support 9d.

In bearing on each end upright of the device, the actuation means comprise a buttress 98a, 98b. Each buttress comprises a central part 980a, 980b in the form of an inclined plane which bears on an end upright and a contact zone 981a, 981b. A carriage 99 is mounted to be mobile in translation on the wormscrew 95. It bears on the contact zone 981b of the buttress 98b and is secured to this contact zone.

A block 96a which bears on the contact zone 981a of the buttress 98a and is secured to this contact zone is fixed to the motor 96. The block 96a therefore forms a stop for the device 9.

The operation of the device is described first of all with reference to FIG. 21.

In this figure, the pusher device 9 is in decompressed position. In this position, the elastic means 101 are taut, such that they store elastic energy. Moreover, the carriage 99 is in its position closest to the bearing 97.

The motor 96 is first of all actuated to drive the screw 95 in a first direction of rotation. This rotational movement provokes the translation of the carriage 99 along the screw, toward the end upright 9a. The carriage 99 then exerts a compression force on the upright 9b via the buttress 98b. In as much as the other end upright 9a is held in its initial position by virtue of the block 96a, the upright 9b approaches, like the intermediate uprights 9c, this other end upright 9a.

The device thus takes the compressed position illustrated in FIG. 22.

This movement of the uprights and of the columns 100 is promoted by the elastic means 101 which tend to be compressed. Furthermore, these elastic means distribute the compression force between the columns.

As indicated previously, the operation of the device 9 is reversible.

Thus, the motor 96 can then be actuated to drive the screw 95 in a second direction of rotation, opposite the first. This rotational movement provokes the translation of the carriage 99 along the screw, away from the end upright 9a. The carriage 99 then exerts a pulling force on the upright 9b via the buttress 98b. In as much as the other end upright 9a is held in its initial position by virtue of the block 96a, the upright 9b is moved apart, like the intermediate uprights 9c, from this other end upright 9a.

The device 9 then reverts to the decompressed position illustrated in FIG. 21.

Here again, the presence of the elastic means makes it possible to distribute the traction between the columns, which ensures a balanced movement apart of the columns.

Reference is now made to FIGS. 16 to 19 which illustrate the use of a pusher device according to the invention in a lifting mechanism.

FIGS. 16 to 19 are front-end views representing the pusher device 8 illustrated in FIG. 6 used in a lifting mechanism. Some references are in common with the skeleton diagram illustrated in FIG. 20.

More specifically, the pusher device 8 is arranged to lift a load 80 (represented by an arrow symbolizing a weight) at the distal end or part of a lever arm 81.

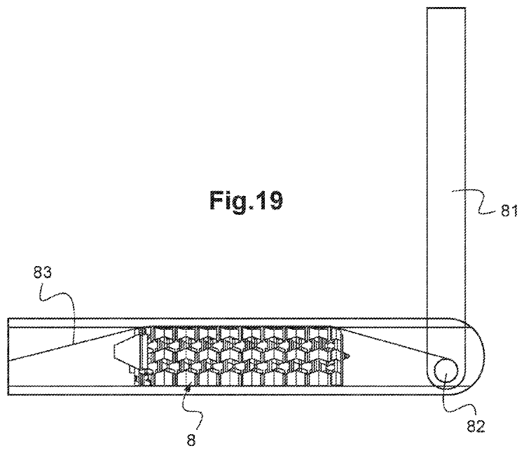

The arm 81 is rotationally mobile about an axis 82 between a first, low vertical position (FIG. 16) and a last, high vertical position (FIG. 19).

A non-extendible or virtually non-extendible strap 83 is tensioned on the pusher device 8, by fixing its proximal end portion 830 to a base (not illustrated in FIG. 16) and its distal end portion 831 to the proximal part 810 of the arm 81. Means can be provided to block the vertical displacement of the strap, for example a roller (not represented), situated facing the axis of rotation 82.

In the position illustrated in FIG. 16, the lever arm is therefore in the low vertical position and the pusher device 8 is at rest.

A compression force is then exerted on the pusher device 8, as was described with reference to FIGS. 7 to 10.

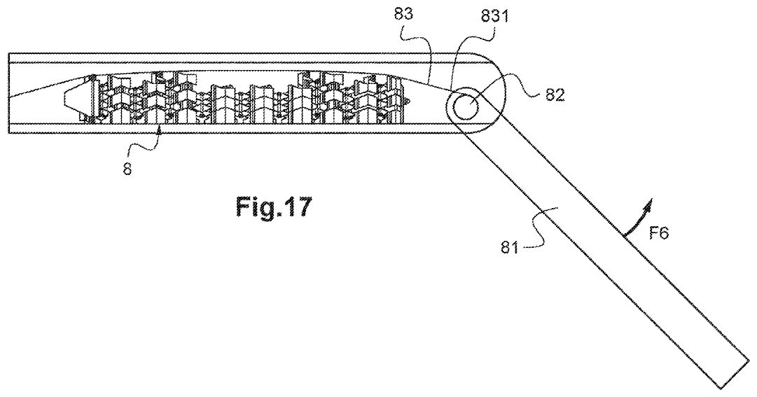

Between the low vertical position illustrated in figure (at −90° with respect to the horizontal) and the intermediate position illustrated in FIG. 17 (at −45° with respect to the horizontal), the device 8 operates as if the strap were absent. The operation of the device is therefore that described with reference to FIGS. 11 to 13.

Thus, it is therefore first of all the outermost columns of the pusher device which are deformed, and it is also an outer region of the strap on which a first tensioning will be applied. It therefore makes it possible to raise the non-extendible strap, which, to compensate, generates an upward movement of the lever arm.

By continuing to exert a compression force on the pusher device 8, successive or simultaneous tensionings are generated on different portions of the strap, which makes it possible to once again move the lever arm 80 upward (arrow F6), as FIG. 17 illustrates.

A compression force still continues to be exerted on the pusher device, so as to generate more upward movements of the different columns forming the device. Each of these vertical movements generates a tensioning of a portion of the non-extendible strap. Each of these tensionings depend on the height gained by each of these columns.

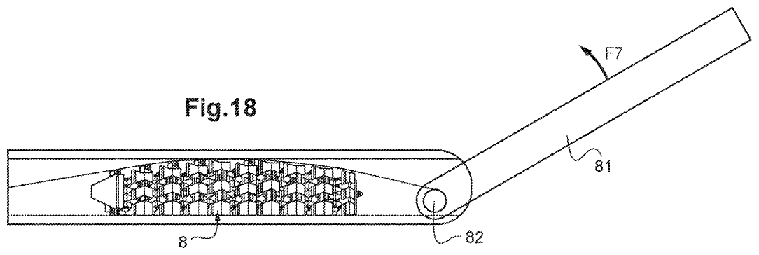

Thus, FIG. 18 illustrates a subsequent step in the operation of the pusher device 8, the latter having caused a horizontal position of the lever arm 81, which continues to turn about the axis 82 (arrow F7) to be exceeded.

Between the position of the lever arm illustrated in FIG. 17 (at −45° with respect to the horizontal) and the position illustrated in FIG. 18 (at +45° with respect to the horizontal), the device 9 operates with a strap which exerts a compression on it. The operation of the device is therefore that described with reference to FIGS. 7 to 10.

FIG. 19 illustrates the fully compressed state of the pusher device 8, in which all the columns have reached their maximum height, as illustrated in FIG. 10.

In this fully compressed state of the pusher device 8, the lever arm 81 is in vertical position. It has therefore performed a rotation of 180° with respect to the initial state illustrated in FIG. 16.

It should be noted that, between the position illustrated in FIG. 18 (at +45° with respect to the horizontal) and that illustrated in FIG. 19 (at +90° with respect to the horizontal), the device 9 operates as if the strap were absent, because it does not compress the device.

Since the pusher device 8 is reversible, a pulling force allows it to revert to the state of rest illustrated in FIG. 6, the lever arm 81 reverting to its low vertical position.

The application of a pusher device according to the invention to the lowering of a lifeboat is described with reference to FIGS. 23A to 23D.

It will be recalled first of all that a lifeboat is put to sea differently depending on the type of craft.

A free-drop craft is a closed craft, disposed on a ramp. Its launch is preceded by a vertical drop of 10 to 20 m which causes it to enter into the water before returning to the surface. Because of its deceleration, when the craft enters into the water, the passengers suffer shocks which can cause injury.

A davit-supported craft can be opened or closed. Winches are provided to load the empty lifeboat but are not always suited to a weight overload likely to occur in an emergency evacuation. To mitigate this difficulty, a system is also provided that allows an all or nothing triggering of the rotation of the davits, to move the lifeboat from away the boat then slow down the paying out of the suspension cable. This system is actuated via handles. Any confusion between the handles leads to an impact between the lifeboat and the boat and risks of capsizing of the lifeboat filled with passengers.

By virtue of the use of pusher devices according to the invention, the launching of a lifeboat can, on the contrary, be performed in total safety and with a reduced energy input.

FIG. 23A illustrates the hull 70 of a boat on which a system 73 for maneuvering a lifeboat 72 is mounted.

This system comprises two arms 730 and 731.

The arm 730 is, at its proximal end 7300, mounted to be rotationally mobile about an axis 732 fixed to the hull 70.

The arm 731 is, at its proximal end 7310, mounted to be rotationally mobile with respect to the arm 730, about an axis 733 situated at the distal end 7301 of the arm 730 opposite the axis 732. The lifeboat 72 is attached to the distal end 7311 of the arm 731, opposite the axis 733, via an articulation.

Each of the arms 730, 731 has associated with it at least one pusher device 734, 735 according to the invention, associated with a strap 734a, 735a. The device 734 is situated in the boat on a support 734b and the device 735 is situated on the arm 730. Thus, the device 734 and the strap 734a form a first system for tensioning a first strap and the device 735 and the strap 735a form a second system for tensioning a second strap.

The strap 734a is tensioned on the device 734 by fixing its proximal end portion 7340a to the support 734b and its distal end portion 7341a to the proximal part 7300 of the arm 730.

The strap 735a is tensioned on the device 735 by fixing its proximal end portion 7350a onto the arm 730 and its distal end portion 7351a to the proximal part 7310 of the arm 731.

The two straps are non-extendible or virtually non-extendible.

In the step 1 illustrated in FIG. 23A, the lifeboat 72 is placed on the hull and it is therefore in a stable position.

The devices 734, 735 are in compressed position so that the two arms 730, 731 are rigid and maintain their position.

Between the step 1 and the step 2 illustrated in FIG. 23B, the device 735 remains in compressed position, while the device 734 is gradually decompressed. This leads to a rotation of the arm 730, in the clockwise direction, about the axis 732, under the effect of gravity, the spacing between the arms 730 and 731 remaining unchanged.

Complementary means are provided to ensure the take-off of the lifeboat.

In the step 2, the lifeboat 72 has taken off from the hull but it is still at least partly above it.

Between the step 2 and the step 3 illustrated in FIG. 23C, the device 735 begins to be decompressed, while the device 734 continues its gradual decompression.

Thus, the spacing between the two arms 730, 731 increases, the arm 731 rotating in the counter-clockwise direction about the axis 733, in order to let the lifeboat be positioned vertically to the axis 733, and the device 734 holding back the dropping of the lifeboat.

In the step 3, the arm 730 is substantially horizontal while the arm 731 is substantially vertical.

Between the step 3 and the step 4 illustrated in FIG. 23D, the phase of lowering of the lifeboat 72 continues until it reaches the surface of the water.

For that, the devices 734 and 735 continue their gradual decompression.

All of this lowering phase is done in a controlled way, without jerks, and the lifeboat is deposited on the water and not cast off. This ensures the safety of the passengers, unlike the known systems.

Since the devices operate reversibly, other steps make it possible to return the lifeboat onto the boat.

The climbing of the passengers into the lifeboat can be done in the step 1 or in the step 2. Obviously, if the passengers enter into the lifeboat only in the step 2, the complementary means require less energy to ensure the take-off of the lifeboat.

In this case, the devices 734 and 735 can be controlled using a simple winch actuated manually by a single person. This can prove advantageous in the event of a current outage on the boat.

As goes without saying and as a result of the above, the present invention is not limited to the embodiments that are more particularly described. It, on the contrary, encompasses all the variants, notably that in which the structure of the pusher mechanism is modified while retaining its principle of operation and alternative embodiments of these mechanisms are retained.

1. A pusher mechanism comprising a column (1, 7) capable of being subjected to a compression or pulling force in operation and having a height (H) defining a first direction, a width (l) and a thickness (E), the thickness (E) being constant, the height (H) being variable in operation between a value at rest (H₀) and a maximum value (H_{M}) and the width (l) being variable in operation between a value at rest (l₀) and a minimum value (lₘ), said column comprising two uprights (2, 3; 27, 37) facing one another extending according to the height (H) and thickness (E), and reversible means (6, 67) supported by said uprights and designed to convert a compression force exerted on the uprights according to the width (l) of the column into a movement according to said first direction of the column whose width (l) then decreases (l<l₀) and whose height (H) increases (H>H₀), and vice versa, characterized in that the reversible means comprise:
at least two corner-forming parts (50 to 59, 60) which extend according to the thickness (E) and have at least one surface defining a first inclined plane (510 to 590; 531 to 571), with respect to a plane at right angles to said first direction, said at least two first parts being each secured to one of the two facing uprights, by being situated on different uprights, and
at least one complementary second part (40 to 43, 407 to 477) which extends according to the thickness (E) and has at least two surfaces each defining a second inclined plane (400 to 403; 410 to 413; 420 to 423; 430 to 433) with respect to said plane, this at least one second part being disposed between two first parts,
the first inclined plane of a first part being designed to slip over one of the second inclined planes of the second part, such that a slippage of the corner-forming first parts over said at least one second part drives a movement according to said first direction of the at least one second part.

2. The pusher mechanism as claimed in claim 1, the uprights (2, 3; 27, 37) of which are produced in at least two independent parts (20 to 24; 30 to 34; 270 to 278; 370 to 374) of which the height, the width and the thickness are constant, their height being less than (H₀).

3. The pusher mechanism as claimed in claim 1, wherein said at least two corner-forming first parts are facing or offset according to the height (H) of the column.

4. The pusher mechanism as claimed in claim 2, wherein the column comprises several complementary second parts disposed adjacent according to said first direction, elastic means (44) being provided to hold said second parts according to this arrangement, during the movements of these second parts according to said first direction.

5. The pusher mechanism as claimed in claim 1, comprising actuation means (94).

6. A pusher device allowing the generation of a series of thrusts staggered in time, comprising at least three pusher mechanisms as claimed in claim 1, linked to one another by their adjacent uprights.

7. The device as claimed in claim 6, wherein at least two columns have adjacent uprights linked to one another by a vertical guideway link.

8. The device as claimed in claim 6 or 7, comprising elastic means between the uprights of the device to link them elastically to one another.

9. A system for tensioning a non-extendible or substantially non-extendible strap (83) extending longitudinally between a distal end portion (831) and a proximal end portion (830), respectively fixed to corresponding attachment points, characterized in that it comprises at least three pusher mechanisms as claimed in claim 1, namely a first pusher mechanism for the transverse tensioning over a first central portion of the strap, and two pusher mechanisms for the transverse tensioning on a second and a third portions of strap situated on either side of the first central portion.

10. The system as claimed in claim 9, further comprising a lever arm (81) extending longitudinally between a proximal part (810) and a distal part supporting a load (80), the proximal part (810) being rotationally mobile about an axis (82) fixed to a base, the distal end portion (831) of the strap being, for its part, fixed to said proximal portion (810) of the arm by one of the attachment points, and the proximal end portion (830) of the strap being fixed to a fixed point forming the second of the attachment points.

11. The system as claimed in claim 9 or 10, wherein the number of pusher mechanisms is equal to n+2 (n≥3), these means being distributed longitudinally along the strap, symmetrically with respect to the central pusher mechanism situated equidistantly between the fixed point and a pulley, an axis of rotation or a rotary return cylinder situated in the same longitudinal plane as the fixed point.

12. A system for maneuvering a lifeboat placed at rest on the hull (70) of a boat, comprising two arms (730, 731) mutually articulated about a first axis (733), the first arm (730) being also articulated on the hull (70) about a second axis (732) and the second arm (731) supporting said lifeboat, and two strap tensioning systems conforming to claim 9, one of them (734, 734a) being situated on the boat and the other (735, 735a) on the first arm (730).
